(19) United States
(12) Patent Application Publication
(10) Pub. No.: US 2005/0089314 A1
(43) Pub. Date: Apr. 28, 2005

(54) Information storage medium with search information file recorded thereon, method and reproducing apparatus for reproducing the information storage medium

(75) Inventors: Hyun-Kwon Chung, Seoul (KR); Jung-wan Ko, Suwon-Si (KR); Jung-kwon Heo, Seoul (KR); Sung-wook Park, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/936,724

(22) Filed: Sep. 9, 2004

(30) Foreign Application Priority Data
Sep. 9, 2003 (KR) 2003-63413

(51) Int. Cl. H04N 5/781

(52) U.S. Cl. 386/125; 386/126

(57) ABSTRACT

An image storage medium with a search information file recorded thereon, a method of and reproducing apparatus reproducing the image storage medium. The image storage medium includes enhanced audio-video (ENAV) files reproducing AV (audio-video) data in an interactive mode, and a search information file that is referred to when accessing the ENAV files. The search information file, which includes search information, is cached in an ENAV buffer and is referred to when accessing the ENAV files. The ENAV files can be read more quickly since the search information regarding the ENAV files are cached and the relevant ENAV files are accessed by referring to the cached search information.

### CROSS-REFERENCE TO RELATED APPLICATIONS

This application claims the priority of Korean Patent Application No. 2003-63413, filed on Sep. 9, 2003 in the Korean Intellectual Property Office, the disclosure of which is incorporated herein in its entirety by reference.

### BACKGROUND OF THE INVENTION

1. Field of the Invention

The present invention relates to an information storage medium that can reproduce audio-video (AV) data recorded thereon in an interactive mode, and a reproducing apparatus and method of reproducing the information storage medium.

2. Description of the Related Art

Interactive digital versatile discs (DVDs) that can reproduce data in an interactive mode by being loaded into a DVD drive installed in a personal computer (PC) are commercially available. AV data is recorded on the interactive DVD according to conventional DVD-video standards and an enhanced AV (ENAV) file to support the interactive mode is also recorded on the interactive DVD. The ENAV file includes a document written in a mark-up language such as a hypertext mark-up language (HTML) or an extensible mark-up language (XML), and another ENAV file that has a script code, and a mark-up resource that is inserted in or linked to the ENAV file.

The AV data recorded on the interactive DVD can be reproduced in one of two modes. In a video mode, the AV data is displayed in the same manner as data from a general DVD. In an interactive mode, an AV screen reproducing the AV data is displayed on a mark-up screen, which is obtained from an ENAV file, by being embedded in the mark-up screen. If the interactive mode is selected by a user, an ENAV file viewer (e.g., a browser that can interpret and display an HTML document), which is installed on a PC and allows a user to view the ENAV file, displays the ENAV file by interpreting and running the ENAV file, which is recorded on the interactive DVD. When the AV data is a movie title, moving images of the movie are displayed on an AV screen and various additional information, such as the film script, a synopsis, and actors' and actresses' photos, are displayed on an interactive screen. The additional information may be displayed in synchronization with the movie title (i.e., AV data). For example, when a particular actor shows up on the AV screen, an ENAV file on the background of the actor can be reproduced and displayed.

In the interactive mode, the PC has to read the AV data as well as a plurality of ENAV files. The PC must analyze a volume structure and a file structure of a file system each time the ENAV files are read. For example, an optical pickup moves 6 times to analyze the volume structure and the file structure each time one file recorded on an interactive DVD is accessed. If it is assumed that it takes 100 msec for the optical pickup to move once, it takes 1200 msec for the optical pickup to read one ENAV file and one image file linked to the ENAV file since the optical pickup has to move a total of 12 times. If there are 5 image files linked to an ENAV file, it takes 6×5×100=3000 msec only to read the files. Thus, images displayed on the AV screen may be broken due to the disappearance of the obtained AV data, even before reading of the AV data is finished.

### SUMMARY OF THE INVENTION

In accordance with an aspect of the present invention, an information storage medium recorded with a data structure in which data supporting an interactive mode can be found and read quickly and efficiently, a method of and reproducing apparatus reproducing from the information storage medium are provided.

According to an aspect of the present invention, there is provided an information storage medium including: enhanced audio-video (ENAV) files reproducing audio-video (AV) data in an interactive mode, and a search information file which is referred to when accessing the ENAV files. The search information file includes search information which is cached at an ENAV buffer in order to be referred to when accessing the ENAV files.

According to an aspect, the ENAV files needed to reproduce the AV data in the interactive mode are interconnected and recorded as one integrated file. The search information file includes the names of the ENAV files, the sizes of the ENAV files, and the locations of the ENAV files.

According to another aspect of the present invention, there is provided an information storage medium including: a video directory in which AV data is stored, and an ENAV directory in which at least one ENAV file reproducing the AV data in an interactive mode are stored. A search information file containing search information accessing the ENAV files is stored in the ENAV directory. In an aspect, the search information is cached in an ENAV buffer for reference.

According to another aspect of the present invention, there is provided a method of reproducing AV data in an interactive mode, the method including: caching in an ENAV buffer a search information file which is referred to when accessing ENAV files, and reading relevant ENAV files with reference to the search information file cached in the ENAV buffer. The method further includes reproducing the AV data in the interactive mode using the read ENAV files.

According to another aspect of the present invention, there is provided an apparatus reproducing AV data recorded on an information storage medium in an interactive mode, the apparatus including: a reader that reads the AV data and a search information file, which is referred to for accessing ENAV files, reproducing the AV data in an interactive mode from the information storage medium; an AV reproducing engine that includes an AV buffer to buffer the AV data, and decodes the AV data and outputs an AV stream; and an ENAV engine that includes an ENAV buffer that caches the search information file read by the reader, commands the reader to read relevant ENAV files by determining the sizes and locations of the ENAV files with reference to the search information file cached in the ENAV buffer, and outputs together an ENAV screen obtained by interpreting the read ENAV files and the AV stream output from the AV reproducing engine by rendering the ENAV screen and the AV stream.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram of a reproducing system according to an embodiment of the present invention;

FIG. 2 is a block diagram of a reproducing apparatus according to an embodiment of the present invention;

FIG. 3 is a view of a volume space of a disk according to an embodiment of the present invention;

FIG. 4 is a structural diagram of a directory tree of a disk according to an embodiment of the present invention;

FIG. 5A is a structural diagram of an exemplary directory tree of a disk according to an embodiment of the present invention;

FIG. 5B is a view of an exemplary search information file and integrated file illustrated in FIG. 5A;

FIG. 6 is a flow chart illustrating a reproducing method according to an embodiment of the present invention; and

FIG. 7 is a flow chart illustrating an exemplary reproducing method according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

In the description of the embodiments, the term “enhanced audio-video (ENAV) file” is used as a generic term for a document written in a mark-up language, such as a hypertext mark-up language (HTML) or an extensible mark-up language (XML), as well as an ENAV file including or linked to a source code written in, for example, script language or JAVA. Furthermore, the term “ENAV file” may be a resource file inserted in an ENAV file or linked with an ENAV file. That is, the ENAV file acts as an application needed to reproduce AV data in an interactive mode, and at the same time, it provides contents to be displayed together with the AV data.

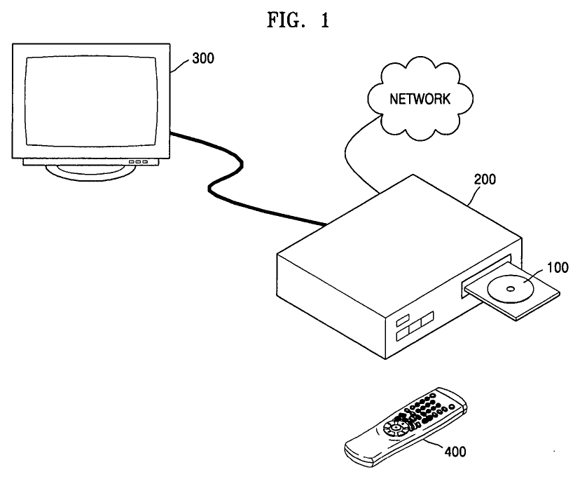

FIG. 1 is a schematic diagram of a reproducing system according to an embodiment of the present invention. Referring to FIG. 1, the reproducing system includes a disk 100, which is an information storage medium according to an embodiment of the present invention, a reproducing apparatus 200, a TV 300 as a display device in the present embodiment of the present invention, and a remote control 400. The remote control 400 receives a control command from a user, and transmits the control command to the reproducing apparatus 200. A disk drive (not shown) is installed in the reproducing apparatus 200 to read data recorded to the disk 100 or to record data on the disk 100. The disk is loaded into the disk drive, and when a user selects an interactive mode, the reproducing apparatus 200 reproduces corresponding AV data in the interactive mode using an ENAV file and transmits the AV data to the TV 300. An AV screen is displayed together with an ENAV screen on the TV 300. In the interactive mode, the AV data is reproduced on the AV screen, which is embedded in the ENAV screen, which is obtained from the ENAV file. That is, the ENAV screen and the AV screen are displayed together. Here, the AV screen denotes a screen on the TV 300 displaying the AV data, and the ENAV screen denotes a screen on the TV 300 displaying the interpreted ENAV file. An interactive screen is a screen in which the AV screen is embedded in the ENAV screen. On the other hand, in a video mode, the AV data is reproduced like conventional DVD-video. That is, only an AV screen obtained by reproducing corresponding AV data is displayed. In the present embodiment, the reproducing apparatus 200 supports both the interactive mode and the video mode. Furthermore, the reproducing apparatus 200 may transmit data by connecting to a network, such as the Internet.

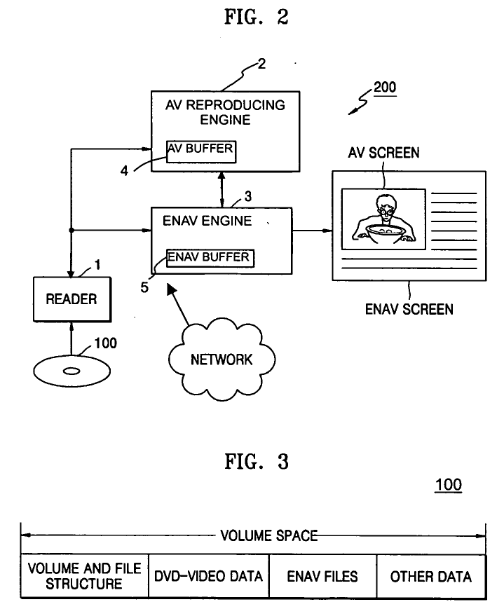

FIG. 2 is a block diagram of the reproducing apparatus 200 according to an embodiment of the present invention. Referring to FIG. 2, the reproducing apparatus 200 includes a reader 1, an AV reproducing engine 2, and an ENAV engine 3.

The reader 1 reads AV data from the disk 100 (i.e., DVD-video data in the present embodiment) according to a control signal received from the ENAV engine 3, and reads ENAV files. Furthermore, the reader 2 reads searching information. The search information is referred to in order to access the ENAV files. In the present embodiment, the search information is configured as a search information file, which will be described in more detail below.

An AV buffer 4 included in the AV reproducing engine 2 buffers the AV data the reader 2 has read. The AV reproducing engine 2 decodes the AV data buffered by the AV buffer and outputs a decoded AV stream to the ENAV engine 3. Since the AV data is recorded as the DVD-video data, the AV reproducing engine 2 is configured as a DVD-video reproducing engine that reproduces DVD-video data. The AV reproducing engine 2 communicates with the ENAV engine 3 via an application program interface (API). That is, the AV reproducing engine 2 transmits to the ENAV engine 3 a property that indicates the operating status of the AV reproducing engine 2 and a trigger to the ENAV engine 3 in response to a request from the ENAV engine 3. When, for example, a quiz corresponding to a fight scene of the movie STAR WARS being reproduced in the interactive mode is to be displayed on an ENAV screen when the fight scene is displayed on the AV screen, the trigger event informs the ENAV engine 3 of the starting and ending points of the displayed fight scene.

The ENAV engine 3 includes an ENAV buffer 5 that is read by the reader 1 or has ENAV files retrieved from a network written thereto. The ENAV buffer may be any form of memory implemented in hardware, software, or a combination of both. The ENAV engine 3 reproduces the ENAV files buffered by the ENAV buffer, and outputs the AV stream, which is input from the AV reproducing engine 2, and the reproduced ENAV files by rendering them. Rendering refers to blending the output so that the AV screen is embedded in a predetermined location of the ENAV screen. The ENAV screen with the AV screen embedded therein is displayed on the TV 300. The ENAV engine 3 is an interpreting engine that interprets and executes mark-up documents, which is one type of ENAV file, written in a mark-up language or a client interpretation program language (e.g., JAVAScript, JAVA, etc.), to reproduce the DVD-video data, which is recorded on the disk 100 in the interactive mode, in the interactive mode. The ENAV engine 3 may include various plug-ins. Such a plug-in can open files in various formats that are inserted in or linked with the ENAV file. That is, the ENAV engine 3 is an ENAV file viewer. For example, the ENAV engine 3 can call up WINDOWS Media Player to reproduce AV data for WINDOWS Media Player. In addition, the ENAV engine 3 can obtain information such as ENAV files related to the DVD-video data by being connected to a network.

In particular, the ENAV engine 3 buffers the search information files, which are read by the reader 1, in the ENAV buffer, and reads needed ENAV files with reference to the search information files stored in the ENAV buffer.

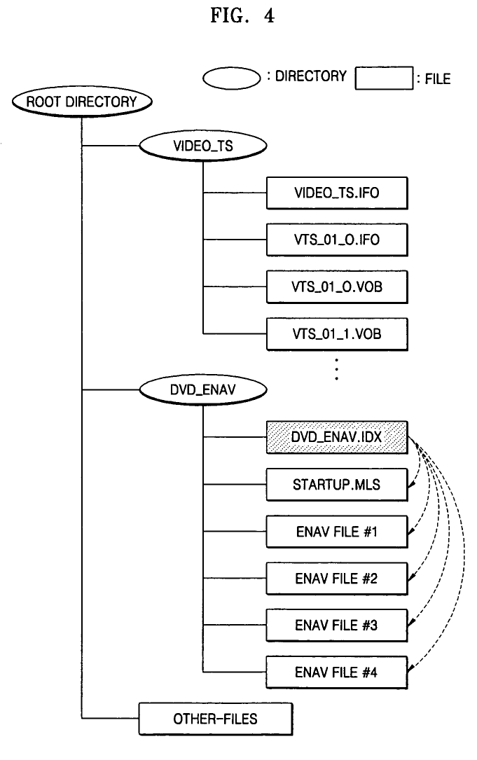

FIG. 3 is a view of a volume space of the disk 100 according to an embodiment of the present invention. Referring to FIG. 3, a volume and file structure region in which information regarding volume and file are recorded, a DVD-video data region in which AV data recorded in a DVD-video format, for example, a video title, is recorded, and an ENAV file region in which ENAV files supporting the interactive mode are recorded are included in the volume space of the disk 100.

A VIDEO_TS.IFO file, which includes reproduction control information for the video title recorded on the disk 100, a VTS_{—}01_{—}0.IFO file, which includes reproducing control information for the first video title, and VTS_{—}01_{—}0.VOB, VTS_{—}01_{—}1.VOB, . . . , files, which are AV data that configures the video title, are recorded in the DVD-video data region. The VTS_{—}01_{—}0.VOB, VTS_{—}01_{—}1.VOB, . . . , files are video titles, that is, video objects (VOB). A video object unit (VOBU), in which a navigation pack, a video pack, and an audio pack are packed, is included in each of the VOBs.

A plurality of ENAV files are recorded in the ENAV file region. That is, a start up file, which is the first file read when the interactive mode is selected, a mark-up document that corresponds to the selected video title, etc., are recorded in the ENAV file region. The ENAV files may include style sheets, which are used to determine the style of mark-up documents, script code files, program files, and resource files linked with the mark-up documents and to be displayed together with the mark-up documents. The ENAV files may include audio files, animation files, image files, and so on. In addition, the ENAV files may include search information files that search other ENAV files according to aspects of the present invention.

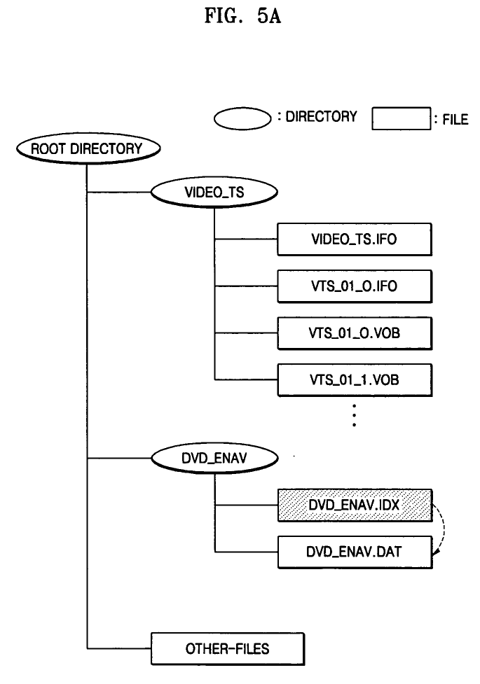

FIG. 4 is a structural diagram of a directory tree of the disk 100 according to an embodiment of the present invention. Referring to FIG. 4, a root directory stores a DVD video directory VIDEO_TS, and an ENAV directory DVD_ENAV in which ENAV data supporting the interactive mode is recorded.

The data described with reference to FIG. 3, that is, VIDEO_TS.IFO, VTS_o1_{—}0.IFO, VTS_{—}01_{—}0.VOB, VTS_{—}01_{—}1.VOB, . . . files are stored in the DVD video directory VIDEO_TS. The data described with reference to FIG. 3, that is, the start up file STARTUP.MLS and ENAV files are stored in the ENAV directory DVD_ENAV. In particular, DVD_ENAV.IDX is stored as a search information file, which is similar to an index. The ENAV engine 3 reads the search information file DVD_ENAV.IDX into the ENAV buffer, and then determines the locations of various relevant ENAV files, for example, ENAV file #1 -#4, with reference to the search information file DVD_ENAV.IDX. Since a region in which a file system is recorded and a region in which the ENAV file is recorded are generally separate, the file system recorded on the disk 100 needs to be read every time the location of the ENAV file is determined, and then the ENAV file is accessed with reference to the file system.

Thus, in a conventional reproducing system there is a danger that the AV data in the AV buffer may be exhausted due to excessive time spent for determining the location of the ENAV file. However, according to the present embodiment, when reading an ENAV file from the disk 100 after reading the search information file from the disk 100 in advance, the location of the ENAV file can be determined with reference to the search information file without having to analyze the file system. Therefore, the ENAV file can be accessed faster than was conventionally possible.

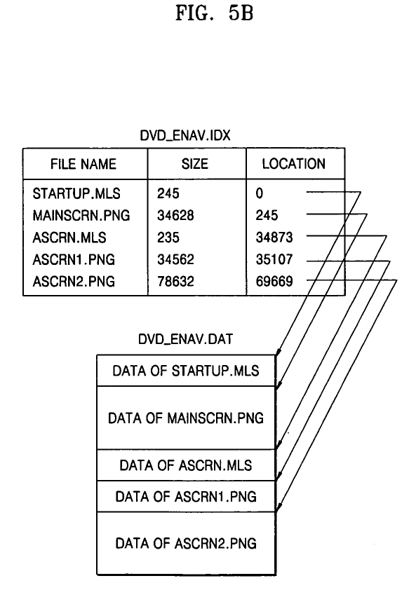

FIG. 5A is a structural diagram of an exemplary directory tree of the disk 100 according to an embodiment of the present invention. Referring to FIG. 5A, a root directory stores a DVD video directory VIDEO_TS, and an ENAV directory DVD_ENAV in which ENAV data supporting the interactive mode is recorded are provided.

The data described with reference to FIG. 3, that is, VIDEO_TS.IFO, VTS_o1_{—}0.IFO, VTS_{—}01_{—}0.VOB, VTS_{—}01_{—}1.VOB, . . . files are stored in the DVD video directory VIDEO_TS. DVD_ENAV.IDX is stored in the ENAV directory DVD_ENAV as a search information file, and an integrated file DVD_ENAV.DAT that integrates a plurality of ENAV files into one file by interconnection or linking are stored in the ENAV directors DVD_ENAV. The ENAV engine 3 reads the search information file DVD_ENAV.IDX into the ENAV buffer, and then determines where an ENAV file is recorded in DVD_ENAV.DAT with reference to the search information file DVD_ENAV.IDX.

FIG. 5B is a view of an exemplary search information file DVD_ENAV.IDX and integrated file DVD_ENAV.DAT illustrated in FIG. 5A. Referring to FIG. 5B, information used to search for ENAV files is included in the search information file DVD_ENAV.IDX. In the present embodiment, the information comprises a file name, a size of the information, and a location of the information. The ENAV engine 3 controls the reader 1 to read the search information file DVD_ENAV.IDX in advance and caches the search information file DVD_ENAV.IDX in the ENAV buffer. ENAV files needed to reproduce AV data in the interactive mode are connected in the order of STARTUP.MLS, MAINSCRN.PNG, ASCRN.MLS, ASCRN1.PNG, and ASCRN2.PNG, and recorded in the integrated file DVD_ENAV.DAT according to the present embodiment. After the ENAV engine 3 detects the size and the starting location of an ENAV file in the search information file DVD_ENAV.IDX cached in the ENAV buffer, the ENAV engine 3 reads the ENAV file via the reader 1.

A reproducing method according to an embodiment of the present invention based on the above-described structure will now be described.

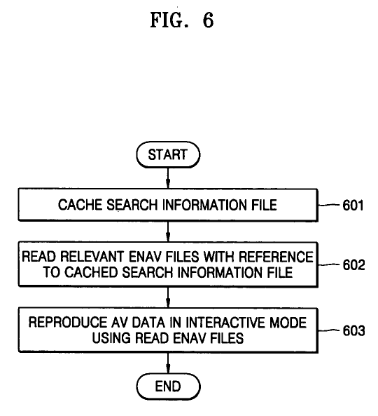

FIG. 6 is a flow chart illustrating a reproducing method according to an embodiment of the present invention. As illustrated in FIG. 6, the reproducing apparatus 200 caches a search information file that is referred to in order to access an ENAV file (Operation 601). Relevant ENAV files are read from the disk 100 with reference to the cached search information file (Operation 602). Next, relevant AV data is reproduced in the interactive mode using the read ENAV file (Operation 603).

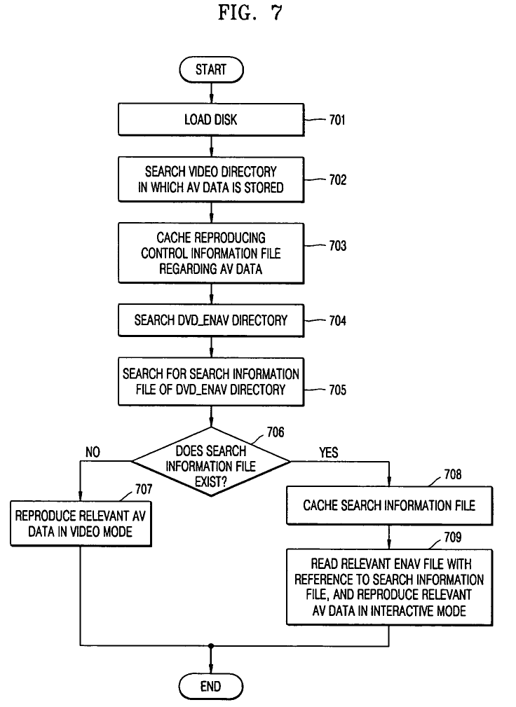

FIG. 7 is a flow chart illustrating an exemplary reproducing method according to an embodiment of the present invention. Referring to FIG. 7, when a user loads the disk 100 into the disk drive installed in the reproducing apparatus 200 (Operation 701), the reproducing apparatus 200 searches a video directory in which AV data is stored (Operation 702) and caches a reproducing information file regarding the AV data (Operation 703). Then, the disk 100 is searched for an ENAV directory in which ENAV files are stored (Operation 704), and a search information file stored in the ENAV directory is located (Operation 705). If the search information file does not exist (Operation 706), the reproducing apparatus 200 reproduces the AV data that configures the selected video title in the video mode (Operation 707). If the search information file exists (Operation 706), the search information file is read from the disk 100 and cached (Operation 708) by the ENAV engine 3 buffer, relevant ENAV files are read with reference to the cached search information file, and the AV data that configures the selected video title is reproduced in the interactive mode (Operation 709).

As such, the search information file used to search for the ENAV files is loaded in the ENAV buffer. That is, according to the present embodiment, the process up to confirming the location of relevant ENAV files is all carried out by accessing a memory. Therefore, an optical pickup (not shown) installed in the reader 1 moves directly to the location at which a start document is recorded and reads data. Thus, the jumping distance of the optical pickup is reduced compared to an optical pickup jumping distance required by a convention reproducing apparatus. When more files are linked to the ENAV files, this effect is more apparent.

The above-described reproducing method can be written as computer programs. Codes and code segments that configure the program can be easily construed by computer programmers skilled in the art to which the present invention pertains. In addition, the program is stored in computer readable media a computer can read, and is read by and operated by the computer, thereby executing the method of automatically selecting a service. The computer readable media includes magnetic recording media, optical recording media, and carrier waves media.

As described-above, according to embodiments of the present invention, ENAV files may be read more quickly by caching search information regarding the ENAV files and accessing relevant ENAV files with reference to the cached search information.

Although a few embodiments of the present invention have been shown and described, it would be appreciated by those skilled in the art that changes may be made in these embodiments without departing from the principles and spirit of the invention, the scope of which is defined in the claims and their equivalents.

1. An information storage medium, comprising:
enhanced audio-video (ENAV) files reproducing audio-video (AV) data in an interactive mode; and
a search information file which is referred to for accessing the ENAV files.

2. The information storage medium of claim 1, wherein the search information file is cached in an ENAV buffer in order to be referred to when accessing the ENAV files.

3. The information storage medium of claim 1, wherein the ENAV files needed to reproduce the AV data in the interactive mode are interconnected and recorded as one integrated file.

4. The information storage medium of claim 1, wherein the search information file comprises names of the ENAV files, sizes of the ENAV files, and locations of the ENAV files.

5. An information storage medium adapted to be reproduced by a reproducing apparatus, comprising:
a video directory in which AV data is stored; and
an ENAV directory in which at least one ENAV file reproducing the AV data in an interactive mode are stored,
wherein a search information file containing search information directing access to each ENAV file is stored in the ENAV directory.

6. The information storage medium of claim 5, wherein the search information is cached in an ENAV buffer for reference by the reproducing apparatus.

7. The information storage medium of claim 5, wherein the ENAV files are interconnected and recorded as one integrated file.

8. The information storage medium of claim 5, wherein the search information file comprises the names of the ENAV files, the sizes of the ENAV files, and the locations of the ENAV files.

9. A method of reproducing AV data stored on an information storage medium in an interactive mode, the method comprising:
caching in an ENAV buffer a search information file which directs access to ENAV files; and
reading the ENAV files according to the search information file cached in the ENAV buffer from the information storage medium.

10. The method of claim 9, further comprising reproducing the AV data in the interactive mode using the read ENAV files.

11. The method of claim 10, wherein the caching of the search information file comprises reading the search information file from an ENAV directory in which the ENAV files are stored on the information storage medium, caching the search information file in the ENAV buffer.

12. The method of claim 10, wherein the reading of the ENAV files comprises reading relevant ENAV files according to names, sizes, and locations of the ENAV files, which are cached in the ENAV buffer.

13. The method of claim 10, wherein the reading of the ENAV files comprises reading relevant ENAV files included in an integrated file in which the ENAV files are interconnected and recorded according to names, sizes, and locations of the ENAV files, which are cached in the ENAV buffer.

14. An apparatus reproducing AV data recorded on an information storage medium in an interactive mode, the apparatus comprising:
a reader that reads the AV data and a search information file, which is referred to in order to access ENAV files, reproducing the AV data in an interactive mode from the information storage medium;
an AV reproducing engine that comprises an AV buffer to buffer the AV data, and decodes the AV data and outputs an AV stream; and
an ENAV engine that comprises an ENAV buffer that caches the search information file read by the reader, commands the reader to read relevant ones of the ENAV files by determining sizes and locations of each ENAV file according to the search information file cached in the ENAV buffer, and outputs together an ENAV screen obtained by interpreting the read ENAV files and the AV stream output from the AV reproducing engine by rendering the ENAV screen and the AV stream.

15. The apparatus of claim 14, wherein the ENAV engine determines a location of the relevant ones of the ENAV files by referring to names, the sizes, and locations of the ENAV files recorded in the search information file, and informs the locations of the ENAV files to the reader.

16. An enhanced audio visual reproducing apparatus, comprising:
a reader which selectively reads audio visual (AV) data and interactive data, comprising an interactive index and interactive files, from an information storage medium;
an AV reproducer which controls the reader to read the AV data and reproduces the AV data read from the information storage medium; and
an ENAV engine which controls the reader to read the interactive index and selectively read and reproduce selected ones of the interactive files corresponding to the AV data when the information storage medium is reproduced in an interactive mode according to the interactive index.

17. The reproducing apparatus of claim 16, wherein the ENAV engine buffers the interactive index corresponding to the interactive files and then reads and reproduces the selected ones of the interactive files from the information storage medium according to the buffered interactive index.

18. A method of reproducing enhanced audio visual data from an information storage medium, comprising:
detecting enhanced audio visual (ENAV) data on the information storage medium when an interactive mode is selected;
reading an interactive index from the information storage medium;
reading and reproducing audio visual data from the information storage medium;
reading selected portions of the ENAV data corresponding to the audio visual data according to the read interactive index; and
reproducing the selected ENAV data together with audio visual data.

19. A method of reproducing enhanced audio visual data from an information storage medium being reproduced in an interactive mode, comprising:
reproducing selected enhanced audio visual (ENAV) data on the information storage medium according to an interactive index read from the information storage medium before reading the ENAV data.

20. The method of claim 19, further comprising:
caching the read interactive index to quickly reproduce the selected ENAV data according to the cached interactive index corresponding audio visual data read from the information storage medium.
